(19) United States
(12) Patent Application Publication
(10) Pub. No.: US 2002/0105752 A1
(43) Pub. Date: Aug. 8, 2002

(54) Magnetic recording medium and magnetic recording/reproducing device

(76) Inventors: Yutaka Soda, Kanagawa (JP); Nobuyuki Nagai, Miyagi (JP); Katsuhiro Kasuga, Kanagawa (JP); Takashi Ota, Miyagi (JP); Hiroshi Meguro, Miyagi (JP); Tadashi Ozue, Kanagawa (JP); Seiichi Onodera, Miyagi (JP)

Correspondence Address: COOPER & DUNHAM LLP, 1185 Avenue of the Americas, New York, NY, 10036, US

(21) Appl. No.: 10/013,412

(22) Filed: Dec. 10, 2001

(30) Foreign Application Priority Data
Dec. 12, 2000 (JP) P2000-376768
Dec. 27, 2000 (JP) P2000-397287
Dec. 28, 2000 (JP) P2000-399950

(51) Int. Cl. G11B 15/00

(52) U.S. Cl. 360/90

(57) ABSTRACT

An anti-static measure is taken against tape guide parts of a magnetic tape cassette by forming the tape guide parts of a conductive material and so on. An antistatic measure against a lid, an upper shell, a transparent window and a lower shell is taken by coating at least either of inside and outside of each of the lid, the upper shell, the transparent window and the lower shell with an anti-static film. A magnetic layer of a magnetic tape has a thickness of from 10 nm or more to 100 nm or less, and also contains oxygen in an amount of from 20 atm % or more to 30 atm % or less in a whole magnetic layer. An information recording surface of the magnetic tape has also a surface resistance of from 10³Ω/inch² or more to 10¹²Ω/inch² or less.

### CROSS REFERENCES TO RELATED APPLICATIONS

The present document is based on Japanese Priority Documents JP 2000-376768, 2000-397287 and 2000-399950, filed in the Japanese Patent Office on Dec. 12, 2000, Dec. 27, 2000 and Dec. 28, 2000, respectively, the entire contents of which being incorporated herein by reference.

### BACKGROUND OF THE INVENTION

1. Field of the Invention

This invention relates to a magnetic recording medium for recording and/or reproducing information, and more specifically, to a magnetic recording medium requiring a magneto resistive head for recording and/or reproducing information, and also a magnetic recording/reproducing device having the magneto resistive head.

2. Description of the Related Art

Recently, with an increase in accepted information content, there is a demand for higher recording density in a magnetic recording/reproducing device for recording and/or reproducing data on a magnetic tape. In the circumstances, it becomes indispensable to use a magneto resistive (MR) head as a magnetic head for reading signals from the magnetic tape, in place of a conventional inductive head. The magneto resistive head is referred to a magnetic head for reading signals recorded onto a magnetic recording medium by making use of magneto resistance effect depending on a MR element and has characteristics inclusive of high signal detection sensitivity enough to produce high reproduction output. For that reason, the magneto resistive head described the above may provide a reduced recording track width on the magnetic tape easily and also may enhance recording density in a line direction, permitting high density recording/reproducing operations.

A helical scan method for recording and/or reproducing signals on the magnetic tape helically wound on a rotary drum rotated along with a magnetic head mounted to the circumference of the rotary drum is well known for the magnetic recording/reproducing device for recording and/or reproducing information on the magnetic tape. The magnetic recording/reproducing device based on the helical scan method provides high slide speed of the magnetic tape relative to the magnetic head by reason that the magnetic tape in the process of traveling operation slides across the magnetic head at high speed for recording and/or reproducing signals, permitting an increase in data transfer rate.

However, problems with the magneto resistive head are that the magneto resistive head is lower in resistance to static electricity than the conventional inductive head to easily cause electrostatic damages by static electricity generated on a magnetic tape cassette when being mounted or being in operation and so on. For instance, electrostatic discharge immunity of an AMR head referred to one of the magneto resistive heads is about little over 200V (See FIG. 1A) and that of a GMR head is about 40V (See FIG. 1B). On the other hand, charged voltage caused by friction and contact or the like between the magneto resistive head and an insulating substance such as polyester, plastic, nylon and vinyl used for the magnetic recording medium of the conventional magnetic tape cassette or the like easily exceeds several kV, leading to voltage sufficient to cause electrostatic damages to the head. In particular, a tape guide part of the magnetic recording medium is generally formed of an insulating material, which is considered to be one of points of accumulation of electrostatic charge.

FIG. 2 shows experimental data representing the relation between the number of times of friction between the magnetic tape and the tape guide part in the magnetic tape cassette and surface potential of the tape guide part. As shown in FIG. 2, it is proved that with the increasing number of times of friction between the magnetic tape and the tape guide part, the electrostatic charge accumulated on the tape guide part increases, leading to 1880V in surface potential of the tape guide part as of a point of time when the tape guide part made friction with the magnetic tape five times over.

### SUMMARY OF THE INVENTION

In view of the above mentioned problems, the present invention has been made to provide a magnetic recording medium and a magnetic recording/ reproducing device, which may prevent a magneto resistive head from electrostatic damages by controlling electrostatic charging on the magnetic recording medium when being mounted or being in operation and so on, and also abrupt transfer of charge from the magnetic recording medium to the magneto resistive head.

To solve the conventional problems, the present invention provides a magnetic recording medium for recording and/or reproducing information with a magneto resistive head. In the magnetic recording medium, an anti-static measure is taken against tape guide parts for holding a magnetic tape at a leader tape part of the magnetic tape.

With the anti-static measure against the tape guide parts to control electrostatic charging on the tape guide parts, the magneto resistive head is prevented from electrostatic damages. The anti-static measure in the magnetic recording medium according to the present invention may be preferably by forming the tape guide parts of a conductive material.

The conductive material preferably has a surface resistance of from 0Ω/inch² or more to 1×10¹²Ω/inch² or less.

The anti-static measure in the magnetic recording medium according to the present invention may be also preferably by coating the tape guide parts with an anti-static film. The anti-static film also preferably has a surface resistance of from 0Ω/inch² or more to 1×10¹²Ω/inch² or less.

The magnetic recording medium according to the present invention preferably comprises conductive machine screws mounted to a bottom of the magnetic recording medium. The conductive machine screws are connected electrically to the ground when the magnetic recording medium is mounted to a magnetic recording/reproducing device.

The present invention also provides a magnetic recording medium for recording and/or reproducing information with a magneto resistive head, in which an anti-static measure is taken against a case.

With the anti-static measure against the case to control electrostatic charging on the case, the magneto resistive head is prevented from electrostatic damages. The anti-static measure in the magnetic recording medium according to the present invention may be preferably by coating at lease either of inside and outside of the case with an anti-static film.

The anti-static film coated on at least either of the inside and the outside of the case of the magnetic recording medium according to the present invention preferably has a surface resistance of from 0Ω/inch² or more to 1×10¹²Ω/inch² or less.

The present invention further provides a magnetic recording medium for recording and/or reproducing information with a magneto resistive head, in which an anti-static measure is taken against a leader tape part of a magnetic tape.

With the anti-static measure against the leader tape part of the magnetic tape to control electrostatic charging on the leader tape part, the magneto resistive head is prevented from electrostatic damages. The anti-static measure in the magnetic recording medium according to the present invention may be preferably by forming the leader tape part of a conductive material.

The anti-static measure may be also preferably by coating the leader tape part with an anti-static film. The anti-static film coated on the leader tape part in the magnetic recording medium according to the present invention preferably has a surface resistance of from 1×10²Ω/inch² or more to 1×10¹²Ω/inch² or less.

The present invention further provides a magnetic recording medium for recording and/or reproducing information with a magneto resistive head, in which a magnetic tape has no leader tape part but a tape end part of the magnetic tape has a tape end detection hole allowing a light to pass through for detecting the tape end.

With the anti-static measure by providing no leader tape part to control electrostatic charging on the leader tape part as an insulator, the magneto resistive head is prevented from electrostatic damages. The present invention further provides a magnetic recording/reproducing device having a magneto resistive head, which further comprises an earth arm for connecting electrically a conductor part provided on a surface of a case of a magnetic recording medium mounted to the magnetic recording/reproducing device to the ground.

With the earth arm, which emits electrostatic charge accumulated on the magnetic recording medium to the ground to control electrostatic charging on the magnetic recording medium by connecting electrically the conductor part provided on the surface of the case of the mounted magnetic recording medium to the ground, the magneto resistive head is prevented from electrostatic damages.

The prevent invention further provides a magnetic recording medium for recording and/or reproducing information with a magneto resistive head, in which an information recording surface allowed to record the information has a surface resistance of from 10^{3Ω}/inch² or more to 10¹²Ω/inch² or less.

The surface resistance of the information recording surface is limited to 10³Ω/inch² or more to control electrostatic charging on the information recording surface. On the other hand, the surface resistance of the information recording surface is limited to 10¹²Ω/inch² or less to control abrupt transfer of charge from the magnetic recording medium to the magneto resistive head.

As has been described in the foregoing, according to the magnetic recording medium of the present invention, since the anti-static measure is taken against the tape guide parts to control electrostatic charging on the magnetic recording medium when being mounted or being in operation and so on, the magneto resistive head may be prevented from electrostatic damages.

According to the magnetic recording medium of the present invention, since the anti-static measure is taken against the case to control electrostatic charging on the magnetic recording medium when being mounted or being in operation and so on, the magneto resistive head may be also prevented from electrostatic damages.

According to the magnetic recording medium of the present invention, since the anti-static measure is taken against the leader tape part of the magnetic tape to control electrostatic charging on the magnetic recording medium when being mounted or being in operation and so on, the magneto resistive head may be also prevented from electrostatic damages.

Since no leader tape part is provided for the magnetic tape to control electrostatic charging on the magnetic recording medium when being mounted or being in operation and so on, the magneto resistive head may be also prevented from electrostatic damages.

Since the magnetic recording/reproducing device of the present invention is provided with the earth arm for connecting electrically the conductor part provided on the surface of the case of the mounted magnetic recording medium to the ground to emit electrostatic charge accumulated on the magnetic recording medium to the ground for controlling electrostatic charging on the magnetic recording medium when being mounted or being in operation and so on, the magneto resistive head may be also prevented from electrostatic damages.

According to the magnetic recording medium of the present invention, since the surface resistance of the information recording surface allowed to record information is limited to 10³Ω/inch² or more to control abrupt transfer of charge from the magnetic recording medium to the magneto resistive head, the magneto resistive head may be also prevented from electrostatic damages.

According to the magnetic recording medium of the present invention, since the surface resistance of the information recording surface is also limited to 10¹²Ω/inch² or less to control electrostatic charging on the magnetic tape of the magnetic recording medium when being in operation, the magneto resistive head may be also prevented from electrostatic damages.

### BRIEF DESCRIPTION OF THE DRAWINGS

The foregoing and other objects and features of the invention will become apparent from the following description of preferred embodiments of the invention with reference to the accompanying drawings, in which:

FIGS. 1A and 1B illustrate electrostatic damage resistance of an AMR head and that of a GMR head, respectively according to the related art;

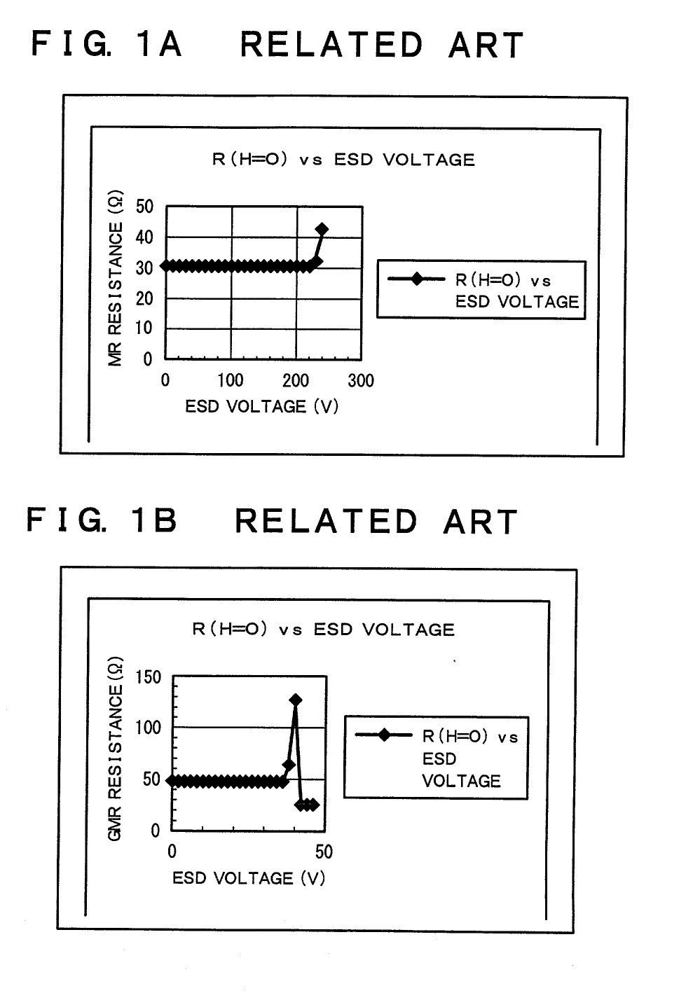

FIG. 2 shows experimental data representing the relation between the number of times of friction between a magnetic tape and a tape guide part in a magnetic tape cassette and surface potential of the tape guide part according to the related art;

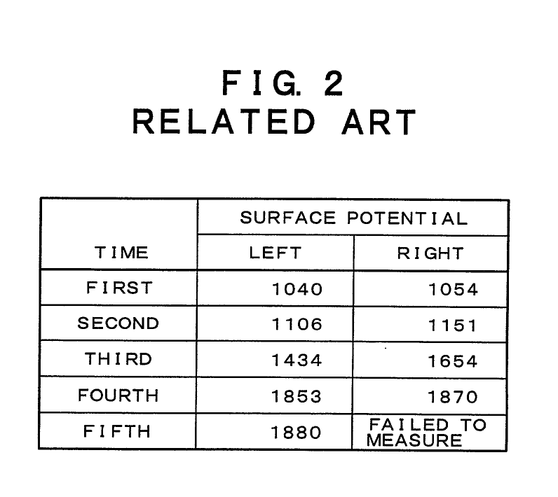

FIG. 3 is a plan view showing a state of a magnetic tape when being drawn from a magnetic tape cassette according to a first embodiment of the present invention;

FIG. 4 is a bottom view showing the magnetic tape cassette according to the first embodiment;

FIG. 5 is a perspective plan view showing the configuration of a magnetic tape drive according to the first embodiment;

FIG. 6 is a perspective plan view showing a state of the magnetic tape cassette when being mounted to the magnetic tape drive according to the first embodiment;

FIG. 7 is a sectional view taken along line VII-VII in FIG. 6;

FIG. 8 is a perspective plan view showing a state of the magnetic tape when being wound on a rotary drum according to the first embodiment;

FIG. 9 is a plan view showing a state of a magnetic tape when being drawn from a magnetic tape cassette according to a third embodiment of the present invention;

FIGS. 10A and 10B illustrate external configurations of a magnetic tape cassette serving as a magnetic recording medium according to a fourth embodiment of the present invention, wherein FIG. 10A is a plan view, and FIG. 10B is a bottom view;

FIGS. 11A, 11B and 11C illustrate other external configurations of the magnetic tape cassette serving as the magnetic recording medium according to the fourth embodiment, wherein FIG. 11A is a front view, FIG. 11B is a rear view, and 11C is a left side view;

FIG. 12 is a flowchart for explaining a process of manufacturing the magnetic tape cassette according to the fourth embodiment;

FIG. 13 is a perspective plan view showing a state of the magnetic tape cassette when being mounted to a magnetic tape drive according to the fourth embodiment;

FIG. 14 is a plan view showing a configuration of a magnetic tape cassette according to a sixth embodiment of the present invention;

FIG. 15 is a perspective plan view showing the configuration of a magnetic tape drive according to the sixth embodiment;

FIG. 16 is a sectional view taken along line XVI-XVI in FIG. 15 showing the magnetic tape drive;

FIG. 17 is a perspective view showing a configuration of a magnetic tape incorporated in a magnetic tape cassette serving as a magnetic recording medium according to a seventh embodiment of the present invention;

FIG. 18 is a plan view showing an external configuration of the magnetic tape cassette according to the seventh embodiment;

FIG. 19 is a perspective plan view showing the configuration of a magnetic tape drive according to the seventh embodiment;

FIG. 20 is a perspective view showing a configuration of a magnetic tape incorporated in a magnetic tape cassette according to a ninth embodiment of the present invention; and

FIG. 21 is an enlarged sectional view showing a detailed configuration of a magnetic tape according to a tenth embodiment of the present invention.

### DESCRIPTION OF THE PREFERRED EMBODIMENTS

A description will be firstly given of a first embodiment according to the present invention.

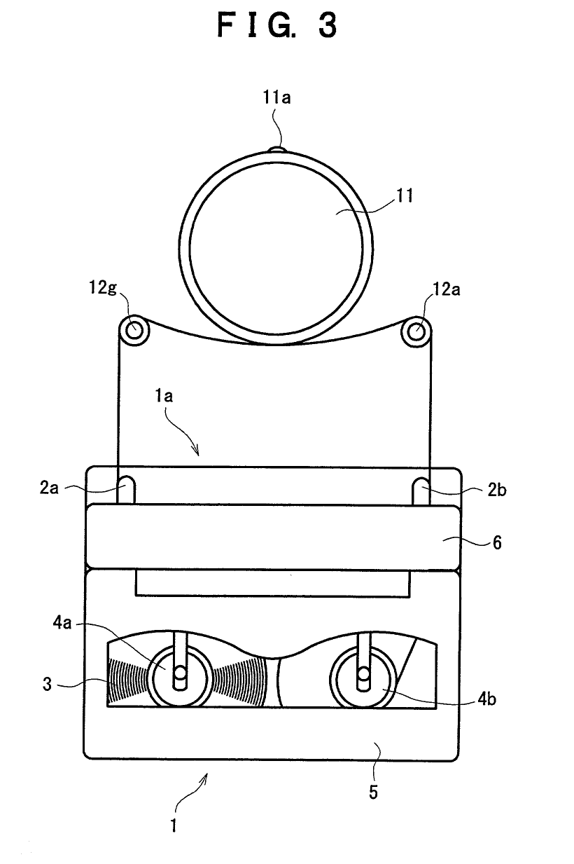

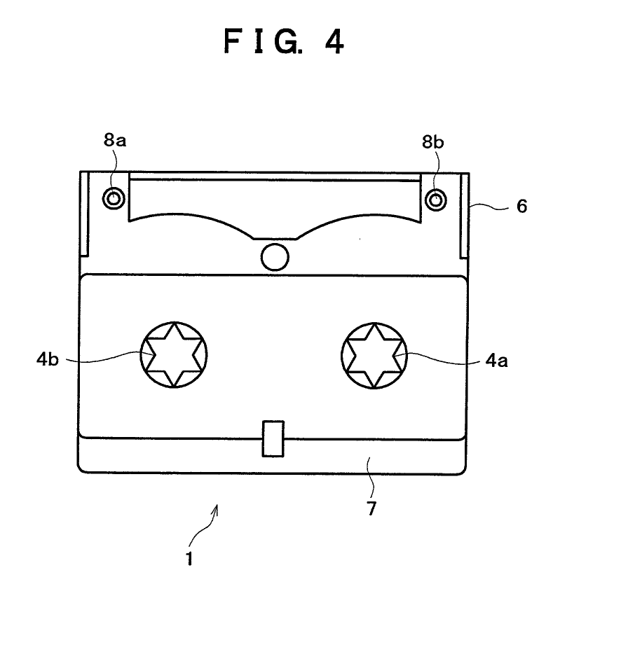

FIG. 3 is a plan view illustrating a state of a magnetic tape 3 when being drawn from a magnetic tape cassette 1 serving as a magnetic recording medium according to the first embodiment. FIG. 4 is a bottom view showing the magnetic tape cassette 1.

The magnetic tape cassette 1 comprises, for instance, the magnetic tape 3 allowed to read various kinds of information with a magneto resistive head 11a, reels 4a, 4b on which the magnetic tape 3 is wound, tape guide parts 2a, 2b for holding the magnetic tape 3 at a leader part of the magnetic tape 3, metal machine screws 8a, 8b provided as conductive machine screws on a bottom side and a case composed of a lid 6, an upper shell 5 and a lower shell 7 or the like to accommodate the magnetic tape 3.

The magnetic tape 3 is composed of, for instance, a polymeric film such as polyethylene-naphthalate, polyether-etherketone, polyphenylene-sulfide, polyamide and polyimide and a ferromagnetic metal thin film such as Co, Co—Ni, Co—Fe, Co—Cr, Co—Ti, Co—Mo, Co—Ni—O, Co—Ni—P and Co—Cr—Nb formed on the polymeric film. Various kinds of information may be recorded onto the magnetic tape 3 by magnetizing the ferromagnetic metal thin film. In recording and/or reproducing information, the magnetic tape 3 is wound on a rotary drum 11 mounted with the magneto resistive head 11a, after being drawn from the magnetic tape cassette 1 with tape guide rollers 12a to 12g or the like. Its detailed description will be given later.

Although a material having a certain degree of mechanical strength inclusive of an insulating material such as polyester and plastic will be available for the reels 4a, 4b, the upper shell 5, the lid 6 and the lower shell 7 without being limited in particular, a conductive material or the like is desirable by reason of the need for anti-static effects and so on.

Each of the tape guide parts 2a, 2b is, for instance, in the shape of a projection formed at a magnetic tape leader part 1a of the magnetic tape cassette 1 as shown in FIG. 3 and has a side face portion at least including a planar part. Thus, the magnetic tape 3 drawn from the magnetic tape cassette 1 is held with the side face portions of the tape guide parts 2a, 2b.

Also, a predetermined anti-static measure is taken against the tape guide parts 2a, 2b. With the anti-static measure against the tape guide parts 2a, 2b to control electrostatic charging on the tape guide parts 2a, 2b of the magnetic tape cassette 1 when being in operation and so on, the magneto resistive head 11a is prevented from electrostatic damages caused by static electricity generated on the tape guide parts 2a, 2b. According to the first embodiment, the anti-static measure against the tape guide parts 2a, 2b may be taken by forming the tape guide parts 2a, 2b of the conductive material.

According to the first embodiment, the conductive material for the tape guide parts 2a, 2b preferably has a surface resistance of from 0Ω/inch² or more to 1×10¹²Ω/inch² or less, for instance. This is because too high surface resistance of the conductive material increases the possibility of causing electrostatic damages to the magneto resistive head 11a with the increasing electrostatic charge on the tape guide parts 2a, 2b of the magnetic tape cassette 1 when being in operation and so on.

In addition, the conductive material for the tape guide parts 2a, 2b more preferably has a surface resistance of 1×10⁶Ω/inch² or more, for instance. This is because too low surface resistance of the conductive material increases the possibility of causing electrostatic damages to the magneto resistive head 11a by abrupt transfer of charge accumulated on the magnetic tape cassette 1 toward the magneto resistive head 11a through the tape guide parts 2a, 2b as the magnetic tape cassette 1 is coming closer to the magneto resistive head 11a.

Examples of the conductive material preferably include, for instance, metal such as stainless steel, a tin oxide material containing tin oxide doped with antimony, an indium oxide material containing indium oxide doped with tin and a zinc oxide material containing zinc oxide doped with aluminum or the like. Specifically, an anti-static agent-contained ABS resin “Toyolac Parrel-TP40”, which is commercially available from Toray Industries, Inc., Japan is desirable.

As the result of forming the tape guide parts 2a, 2b using the anti-static agent-contained ABS resin “Toyolac Parrel-TP40” experimentally as one embodiment, it was proved that an absolute value of the electrostatic charge on the tape guide parts 2a, 2b at a temperature of 27° C. with a humidity of 60% might be reduced to about 0 to 5V.

The metal machine screws 8a, 8b are formed of a metal such as stainless steel or other conductive material, for instance, and are mounted to a bottom of the magnetic tape cassette 1 as shown in FIG. 4. The metal machine screws 8a, 8b are also connected electrically to the ground when the magnetic tape cassette 1 is mounted to the magnetic recording/reproducing device, for instance, permitting emission of static electricity generated on the magnetic tape cassette 1 to the ground. Its detailed description will be given later.

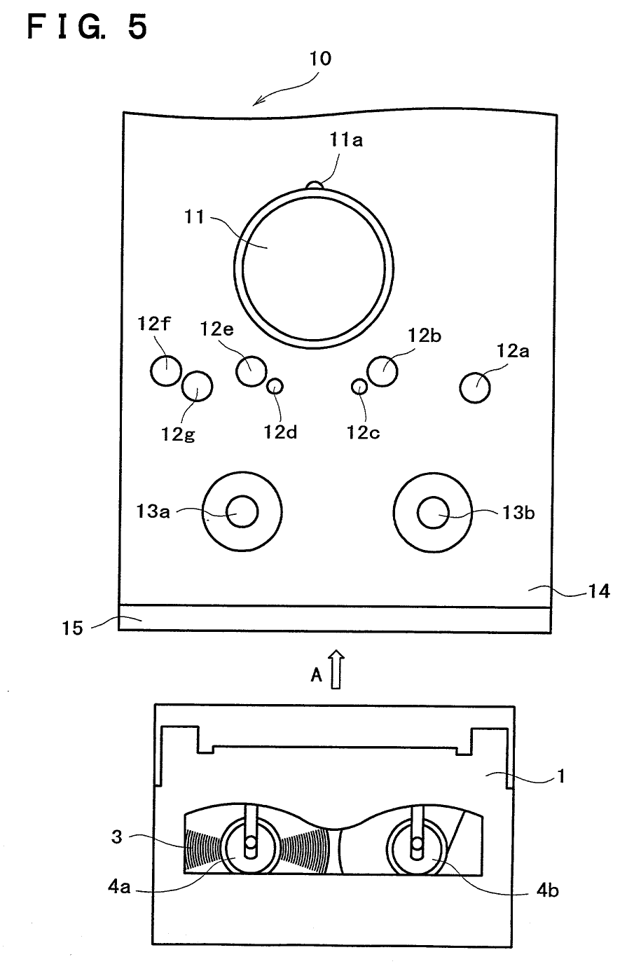

FIG. 5 is a perspective plan view illustrating a configuration of a magnetic tape drive 10 serving as the magnetic recording/reproducing device according to the first embodiment. The magnetic tape drive 10 comprises, for instance, the magneto resistive head 11a for reproducing various kinds of information on the magnetic tape 3, a recording head (not shown) for recording various kinds of information onto the magnetic tape 3, the rotary drum 11 mounted with the magneto resistive head 11a, reel supports 13a, 13b accepting the reels 4a, 4b of the magnetic tape cassette 1 when being mounted, the tape guide rollers 12a to 12g for winding the magnetic tape 3 drawn from the magnetic tape cassette 1 on the rotary drum 11 while holding the magnetic tape 3, a chassis 14 placed at the bottom and a front panel 15 having a cassette insertion part allowing insertion of the magnetic tape cassette tape 1.

According to the first embodiment, the magneto resistive head 11a is referred to a read-only magnetic head for reading signals recorded onto the magnetic tape by making use of the magneto resistance effect depending on the MR element as described the above.

The rotary drum 11 is, for instance, in the shape of a rotary cylindrical body having a cylindrical side surface portion mounted with the magneto resistive head 11a and the recording head (not shown) and is rotated with a centerline of the cylindrical body as an axis of rotation in recording and/or reproducing information on the magnetic tape 3.

Each of the tape guide rollers 12a to 12g is, for instance, in a shape of a cylindrical rotary body rotated with a centerline of the cylindrical rotary body as an axis of rotation. Although a material having a certain degree of mechanical strength will be available for the tape guide rollers 12a to 12g without being limited in particular, a conductive material such as a metal is desirable by reason of the need for anti-static effects and so on.

Each of the reel supports 13a, 13b is, for instance, in a shape of a rotary body driven with motor power (not shown) to rotate the reels 4a, 4b of the mounted magnetic tape cassette 1 for allowing the magnetic tape 3 to travel. Although a material having a certain degree of mechanical strength will be available for the reel supports 13a, 13b without being limited in particular, a conductive material is desirable by reason of the need for anti-static effects and so on.

The chassis 14 is, for instance, in a shape of a planar plate mounted to a bottom of the magnetic tape drive 10. Although a material having a certain degree of mechanical strength inclusive of a conductive material such as stainless steel and other metal and an insulating material such as plastic will be available for the chassis 14 without being limited in particular, the conductive material is desirable by reason of the needs for anti-static effects, connection of the metal machine screws 8a, 8b to the ground and so on. It is also desirable to connect electrically the chassis 14 to the ground by the similar reason.

The front panel 15 is, for instance, in a shape of a plate having a substantially rectangular cassette insertion part (not shown). Although a material having a certain degree of mechanical strength inclusive of an insulating material such as plastic will be available for the front panel 15 without being limited in particular, a conductive material or the like is desirable by reason of the need for anti-static effects and so on.

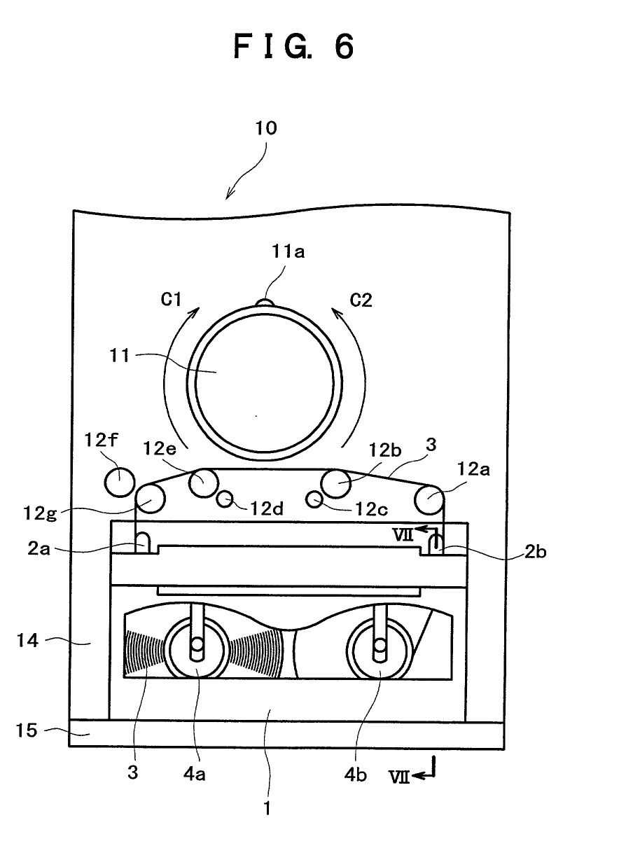

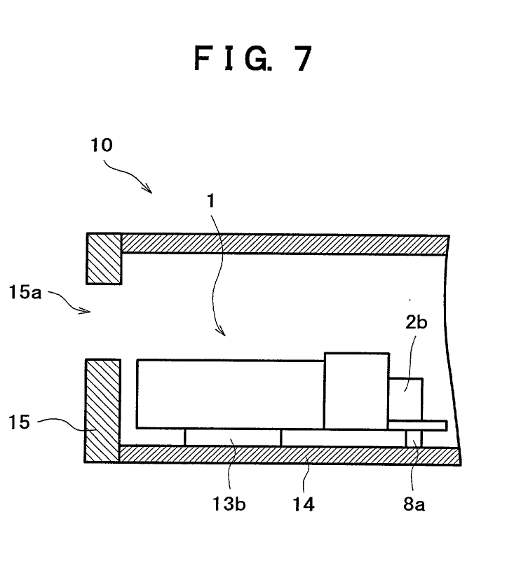

A description will now be given of the operation of mounting the magnetic tape cassette 1 to the magnetic tape drive 10. FIG. 6 is a perspective plan view illustrating a state of the magnetic tape cassette 1 when being mounted to the magnetic tape drive 10, and FIG. 7 is a sectional view taken along a line VII-VII in FIG. 6.

The magnetic tape cassette 1 is mounted to the magnetic tape drive 10 by inserting the magnetic tape cassette 1 in the direction A shown in FIG. 5 through a cassette insertion part 15a provided in the front panel 15.

The magnetic tape cassette 1 mounted to the magnetic tape drive 10 is disposed with the metal machine screw 8a keeping in contact with a part of the chassis 14, as shown in FIG. 7. When the metal machine screw 8a and the chassis 14 are formed of the conductive material, and the chassis 14 is connected to the ground, for instance, the metal machine screw 8a is supposed to be connected electrically to the ground through the chassis 14. Incidentally, although the embodiment of allowing the metal machine screw 8a to connect electrically to the ground through the chassis 14 is shown in FIG. 7, the metal machine screw 8b will be also enough to connect electrically to the ground through the chassis 14. Although the embodiment of allowing the metal machine screws 8a, 8b to connect electrically to the ground through the chassis 14 is shown, other methods are also applicable to connect electrically at least one of the metal machine screws 8a, 8b to the ground.

When the magnetic tape cassette 1 is placed in the magnetic tape drive 10, the operation of winding the magnetic tape 3 on the rotary drum 11 is started. As shown in FIG. 6, the magnetic tape 3 is drawn from the magnetic tape cassette 1 mounted in the magnetic tape drive 10 with the tape guide rollers 12a to 12e and 12g. The drawn magnetic tape 3 is wound on the rotary drum 11 with the tape guide rollers 12a to 12e and 12g transferred (in the directions C1 and C2) so as to enclose the rotary drum 11, while being held with the tape guide rollers 12a to 12e and 12g.

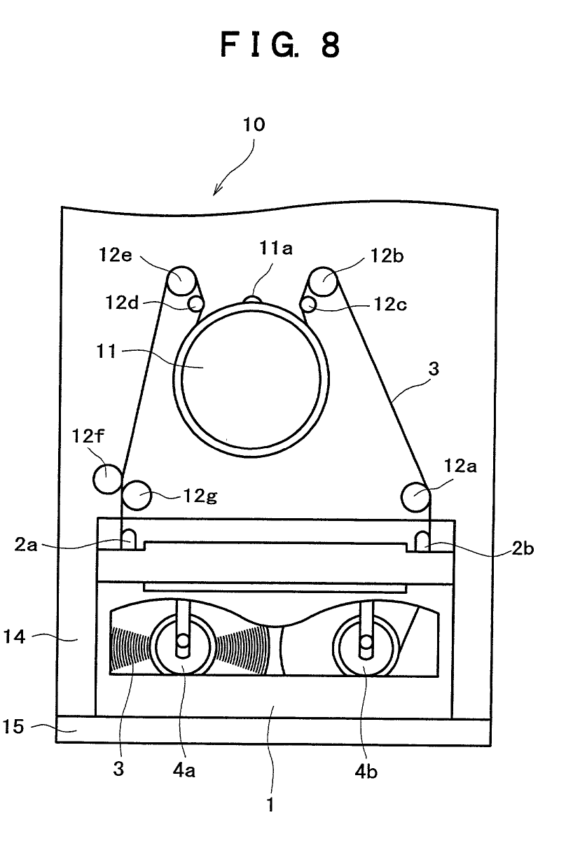

FIG. 8 is a perspective plan view illustrating the state of the magnetic tape 3 when being wound on the rotary drum 11. The magnetic tape 3 wound on the rotary drum 11 as described the above starts traveling with the reel parts 4a, 4b rotated by rotational power transmitted from the reel supports 13a, 13b for recording and/or reproducing various kinds of information with the recording head and the magneto resistive head 11a mounted on the rotary drum 11 which is being in operation.

The tape guide parts 2a, 2b hold the magnetic tape 3 at all times to thereby cause predetermined static electricity by friction between the tape guide parts and the magnetic tape 3 when the magnetic tape 3 is wound on the rotary drum 11 and is in traveling operation. However, the predetermined anti-static measure against the tape guide parts 2a, 2b as described above makes it possible to control the resultant electrostatic charging on the tape guide parts 2a, 2b.

The metal machine screws 8a, 8b connected electrically to the ground in advance as described above make it possible to emit static electricity generated on the tape guide parts 2a, 2b to the ground when the magnetic tape 3 is wound on the rotary drum 11 and is in traveling operation, permitting control of electrostatic charging on the tape guide parts 2a, 2b.

According to the first embodiment, since the predetermined anti-static measure is taken against the tape guide parts 2a, 2b as described the above to control electrostatic charging on the tape guide parts 2a, 2b, the magneto resistive head 11a may be prevented from electrostatic damages.

Since the anti-static measure is taken against the tape guide parts 2a, 2b by forming the tape guide parts 2a, 2b of the conductive material to control electrostatic charging on the tape guide parts 2a, 2b, the magneto resistive head 1ha may be also prevented from electrostatic damages.

Since the surface resistance of the conductive material for the tape guide parts 2a, 2b is limited to the range of 0Ω/inch² or more to 1×10²Ω/inch² or less to control electrostatic charging on the tape guide parts 2a, 2b, the magneto resistive head 11a may be also prevented from electrostatic damages.

Since the tape guide parts 2a, 2b are formed of a metal to control electrostatic charging on the tape guide parts 2a, 2b, the magneto resistive head 11a may be also prevented from electrostatic damages.

Further, since the metal machine screws 8a, 8b provided on the bottom of the magnetic tape cassette 1 make it possible to emit static electricity generated on the tape guide parts 2a, 2b to the ground to control electrostatic charging on the tape guide parts 2a, 2b by connecting electrically the metal machine screws 8a, 8b to the ground when the magnetic tape cassette 1 is mounted to the magnetic tape drive 10, the magneto resistive head 11a may be also prevented from electrostatic damages.

Incidentally, it is to be understood that the present invention is not limited to the above embodiment.

A description will now be given of a second embodiment according to the present invention. The second embodiment is referred to a modification of the first embodiment and is different from the first embodiment only in a way of the anti-static measure against the tape guide parts 2a, 2b. A difference between the first embodiment and the second embodiment will be described mainly in the following, while a description of portions common to the first and second embodiments will be omitted.

According to the second embodiment, with an anti-static measure by coating the tape guide parts 2a, 2b with an anti-static film to control electrostatic charging on the tape guide parts 2a, 2b, the magneto resistive head 11a is prevented from electrostatic damages.

A material for the anti-static film preferably has surface resistance of from 0Ω/inch² or more to 1×10¹²Ω/inch² or less, for instance. This is because too high surface resistance of the information recording surface of the anti-static film increases the possibility of causing electrostatic damages to the magneto resistive head 11a with the increasing electrostatic charge on the tape guide parts 2a, 2b of the magnetic tape cassette 1 when being in operation and so on.

Examples of the anti-static film preferably include, for instance, an anti-static film (as disclosed in Japanese Patent Application Laid-open No. 2000-186218) formed by using a conductive resin composition consisting of a water-soluble conductive high polymer such as water-soluble conductive polyaniline, water-soluble conductive polypyrrole, water-soluble conductive polythiophene, water-soluble conductive polyparaphenine and water-soluble conductive polyparaphenylene-vinylene and a denatured polyester resin containing a hydrophilic group such as sulfonic acid, glycol, polyethylene-glycol, hydroxyl group and carboxyl group in molecules; an anti-static film (as disclosed in Japanese Patent Application Laid-open No. 2000-169685) formed by using a conductive resin composition containing a phenolic antioxidant mixed in a composition consisting of polyarylate and a conductive filler; an anti-static film (as disclosed in Japanese Utility Model Laid-open No. Hei 6-20040) formed by vacuum-evaporating a material containing a fourth periodic element such as Cr, Cu, Fe, Co and Ni and an anti-static film (as disclosed in Japanese Patent Publication No. 2821762) formed by mixing a conducting composition formed by mixing conductive zinc oxide powder with natural organic fiber powder such as pulp for adhering to each other in a resin material or like anti-static films, in addition to a tin oxide material containing tin oxide doped with antimony, an indium oxide material containing indium oxide doped with tin and a zinc oxide material containing zinc oxide doped with aluminum or the like.

As a result of coating the tape guide parts 2a, 2b with the anti-static film experimentally as one embodiment, it was proved that an absolute value of the electrostatic charge on the tape guide parts 2a, 2b at a temperature of 27° C. with a humidity of 60% might be reduced to 0 to 3V.

According to the second embodiment, since the anti-static measure is taken against the tape guide parts 2a, 2b by coating the tape guide parts 2a, 2b with the anti-static film as described the above to control electrostatic charging on the tape guide parts 2a, 2b, the magneto resistive head 11a may be prevented from electrostatic damages.

Since the surface resistance of the conductive material for the anti-static film on the tape guide parts 2a, 2b is limited to the range of 0Ω/inch² or more to 1×10¹²Ω/inch² or less to control electrostatic charging on the tape guide parts 2a, 2b, the magneto resistive head 11a may be also prevented from electrostatic damages.

Since the tape guide parts 2a, 2b are coated with a metal to control electrostatic charging on the tape guide parts 2a, 2b, the magneto resistive head 11a may be also prevented from electrostatic damages.

Incidentally, it is to be understood that the present invention is not limited to the above embodiments.

A description will now be given of a third embodiment according to the present invention. The third embodiment is also referred to a modification of the first embodiment and is different from the first embodiment only in a way of the anti-static measure against tape guide parts 22a, 22b. A difference between the first embodiment and the third embodiment will be mainly described in the following, while a description of portions common to the first and third embodiments will be omitted.

According to the third embodiment, with an anti-static measure by holding the magnetic tape with a roller rotary mechanism provided for each tape guide part to control electrostatic charging on the tape guide parts, the magneto resistive head 11a is prevented from electrostatic damages.

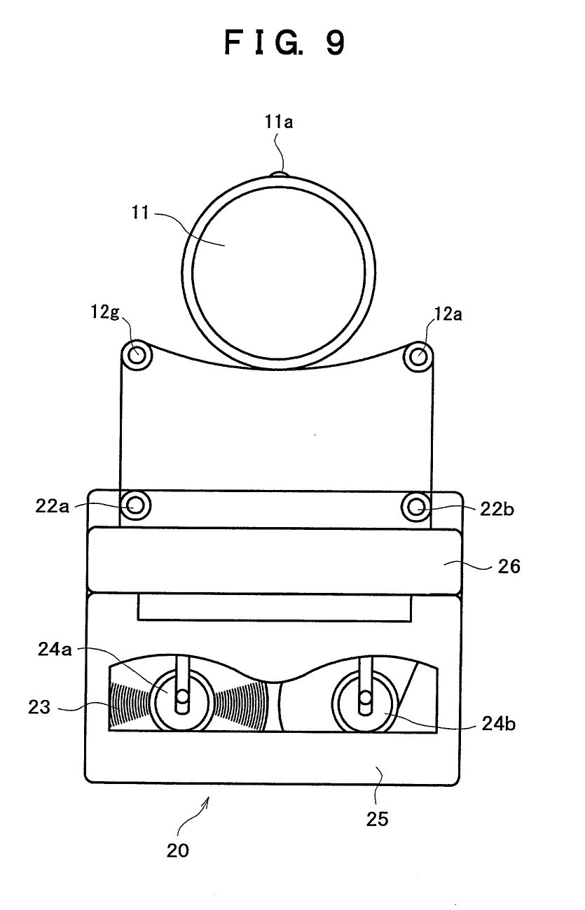

FIG. 9 is a plan view showing the state of a magnetic tape 23 when being drawn from a magnetic tape cassette 20 serving as a magnetic recording medium according to the third embodiment. The magnetic tape cassette 20 comprises, for instance, the magnetic tape 23, reels 24a, 24b, the tape guide parts 22a, 22b, a lid 26, an upper shell 25, metal machine screws (not shown) and a lower shell 7 or the like similarly to the first embodiment, except that the tape guide parts 22a, 22b have the roller rotary mechanisms.

As described the above, each of the tape guide parts 22a, 22b is, for instance, in the shape of a cylindrical rotary body rotated with a centerline of the cylindrical rotary body as an axis of rotation. Although a material having a certain degree of mechanical strength will be available for the tape guide parts 22a, 22b without being limited in particular, a conductive material is desirable by reason of the need for anti-static effects and so on. The conductive materials having been described in the first embodiment, for instance, are preferably available for the tape guide parts in the third embodiment.

The anti-static measure may be also taken by coating the tape guide parts 22a, 22b with an anti-static film. In this case, the similar material and the similar method to the second embodiment, for instance, are preferably applied to coat the tape guide parts 22a, 22b with the anti-static film.

As shown in FIG. 9, the magnetic tape 23 drawn from the magnetic tape cassette 20 is held with side surfaces of the tape guide parts 22a, 22b provided in the shape of the cylindrical rotary bodies, for instance. For that reason, the magnetic tape 23, when being wound on the rotary drum 11 or being in traveling operation, is held along with rotation of the tape guide parts 22a, 22b, providing lower friction between the magnetic tape 23 and the tape guide parts 22a, 22b than that in the first embodiment having the tape guide parts 2a, 2b fixed in position. As a result, it becomes possible to decrease static electricity generated on the tape guide parts 22a, 22b.

Since the magnetic tape 23 is held with the roller rotary mechanisms provided for the tape guide parts 22a, 22b as described the above, the friction between the magnetic tape 23 and the tape guide parts 22a, 22b may be reduced to control static electricity generated on the tape guide parts 22a, 22b, and as a result, the magneto resistive head 11a may be prevented from electrostatic damages caused by the generated static electricity.

Since the roller rotary mechanisms of the tape guide parts 22a, 22b are formed of the conductive material to control electrostatic charging on the tape guide parts 22a, 22b, the magneto resistive head 11a may be also prevented from electrostatic damages.

Since the roller rotary mechanisms of the tape guide parts 22a, 22b are coated with the anti-static film to control electrostatic charging on the tape guide parts 22a, 22b, the magneto resistive head 11a may be also prevented from electrostatic damages.

Incidentally, it is to be understood that the present invention is not limited to the above embodiments.

A description will now be given of a fourth embodiment according to the present invention.

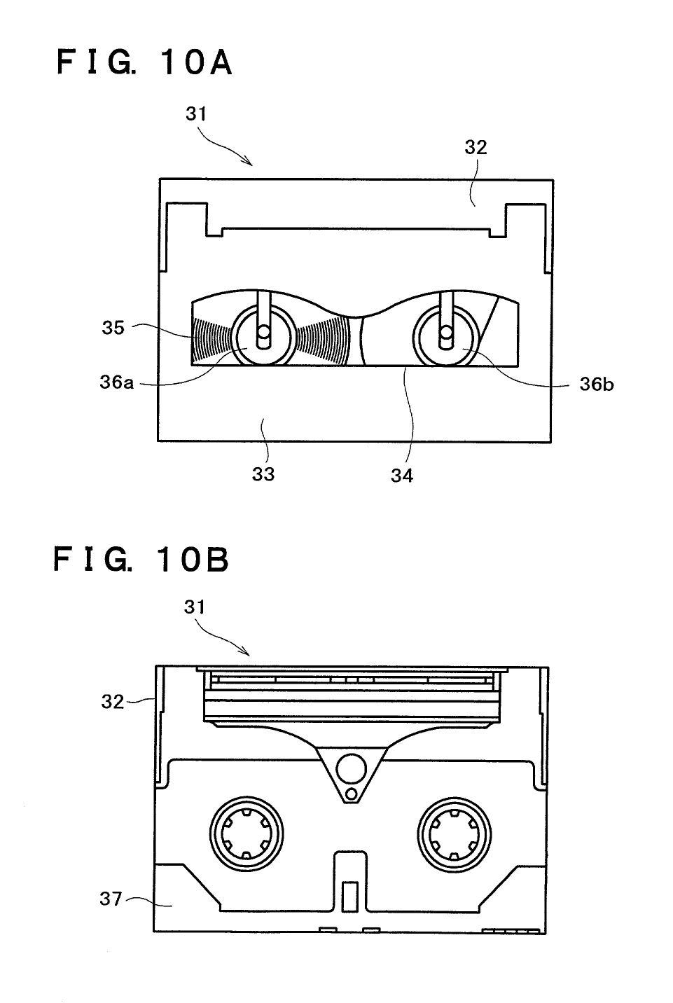

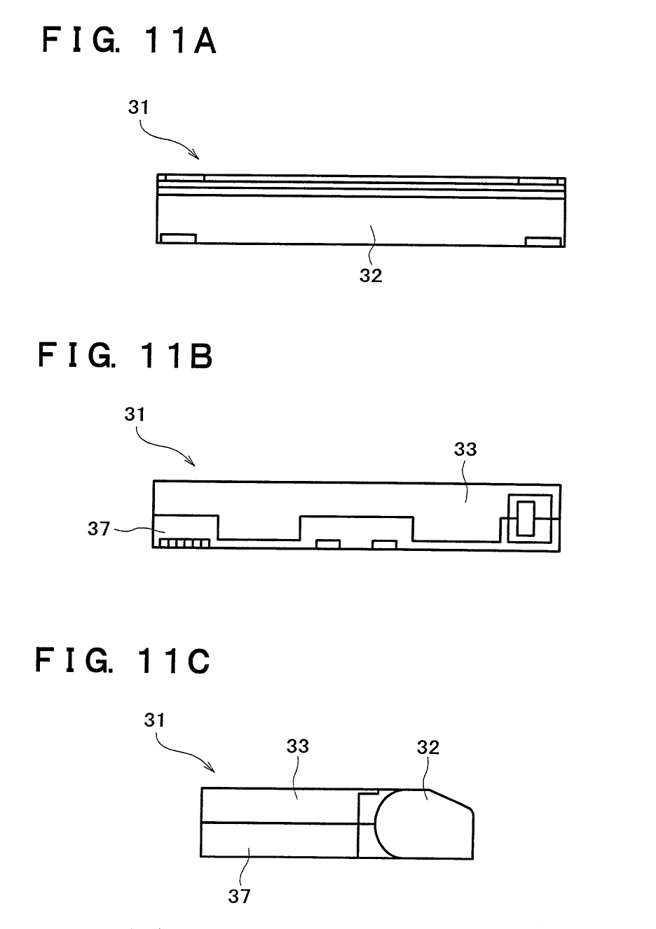

FIGS. 10 and 11 illustrate an external configuration of a magnetic tape cassette 31 serving as a magnetic recording medium according to the fourth embodiment. FIGS. 10A, 10B, 11A, 11B and 11C are a plan view, a bottom view, a front view, a rear view and a left side view, respectively, showing the magnetic tape cassette 31.

As shown in FIGS. 10 and 11, the magnetic tape cassette 31 in the fourth embodiment comprises, for instance, a magnetic tape 35 allowed to record various kinds of information with a magneto resistive head, reels 36a, 36b on which the magnetic tape 35 is wound and a case composed of a lid 32, an upper shell 33, a transparent window 34 and a lower shell 37 to accommodate the magnetic tape 35. Incidentally, the transparent window 34 in the fourth embodiment is for ensuring a residual quantity or the like of the magnetic tape 35.

The fourth embodiment is similar in basic configuration to the first embodiment, except that the case inclusive of the lid 32, the upper shell 33, the transparent window 34 and the lower shell 37 in the fourth embodiment is formed of an insulating material such as polyester and plastic, for instance, and the anti-static measure is taken against the case inclusive of the lid 32, the upper shell 33, the transparent window 34 and the lower shell 37. With the anti-static measure against the case to control electrostatic charging on the case of the magnetic tape cassette 31 when being mounted to the magnetic tape drive or being in operation and so on, the magneto resistive head may be prevented from electrostatic damages caused by static electricity generated on the case.

The anti-static measure against the case may be taken by coating at least either of the inside and the outside of the case inclusive of the lid 32, the upper shell 33, the transparent window 34 and the lower shell 37 with an anti-static film. It is more desirable to coat both the inside and the outside of the case inclusive of the lid 32, the upper shell 33, the transparent window 34 and the lower shell 37 with the anti-static film for providing further increased anti-static effects on the case.

A material for the anti-static film preferably has a surface resistance of from 0Ω/inch² or more to 1×10¹²Ω/inch² or less, for instance. This is because too high surface resistance of the information recording surface of the anti-static film increases the possibility of causing electrostatic damages to the magneto resistive head with the increasing electrostatic charge on the case of the magnetic tape cassette 31 when being in operation.

The material for the anti-static film more preferably has surface resistance of 1×10^{12 Ω/inch}² or more, for instance. This is because too low surface resistance of the anti-static film increases the possibility of causing electrostatic damages to the magneto resistive head coming closer to the magnetic tape cassette 31 by abrupt transfer of charge accumulated on the magnetic tape cassette 31 toward the magneto resistive head through the anti-static film as the magnetic tape cassette 31 is coming closer to the magneto resistive head.

Examples of the anti-static film preferably include, for instance, an anti-static film (as disclosed in Japanese Patent Application Laid-open No. 2000-186218) formed by using water-soluble conductive polyaniline, water-soluble conductive polypyrrole, water-soluble conductive polythiophene, water-soluble conductive polyparaphenine, water-soluble conductive polyparaphenylene-vinylene or the like; an anti-static film (as disclosed in Japanese Patent Application Laid-open No. 2000-169685) formed by using a conductive resin containing a phenolic antioxidant mixed in a composition consisting of polyarylate and conductive filler; an anti-static film (as disclosed in Japanese Utility Model Laid-open No. Hei 6-20040) formed by vacuum-evaporating a material containing a fourth periodic element such as Cr, Cu, Fe, Co and Ni and an anti-static film (as disclosed in Japanese Patent No. 2821762) formed by using a cationic surfactant such as quarternary ammonium salt compound, aliphatic amine and its derivative, benzimidazole derivative and aliphatic amide derivative, an anion surfactant such as alkylphosphoric ester-Na, alkylphenol-polyethylene-glycol sulfuric ester-Na and polystyrene-sulfonate and a non-ionic surfactant such as polyoxyethylene-aliphatic ester and polyoxyethylene-alkyl ester or like anti-static films, in addition to a tin oxide material containing tin oxide doped with antimony, an indium oxide material containing indium oxide doped with tin and a zinc oxide material containing zinc oxide doped with aluminum or the like.

As the result of coating the case inclusive of the lid 32, the upper shell 33, the transparent window 34 and the lower shell 37 with the anti-static film experimentally as one embodiment, it was proved that an absolute value of the electrostatic charge on the lid 32 or the like at a temperature of 27° C. with a humidity of 60% might be reduced to about 3V.

The anti-static film coated at least on either of the inside and the outside of the transparent window 34 is preferably made transparent. Thus, transparency is provided securely for the transparent window 34 already coated with the anti-static film enough to permit the operation of ensuring the residual quantity or the like of the magnetic tape 35 through the transparent window 34. Incidentally, the anti-static film is not always made completely colorless and transparent, but may be formed of a somewhat colored transparent material or a semitransparent material having transparency of less than 100.

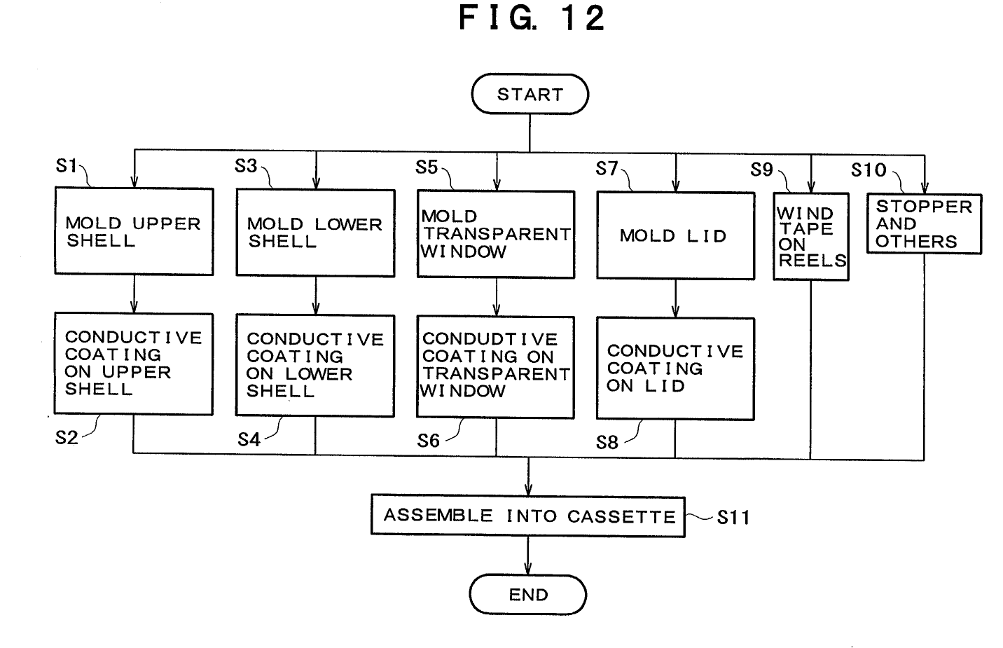

A description will now be given of the process of manufacturing the magnetic tape cassette 31 according to the fourth embodiment. FIG. 12 is a flowchart for explaining the process of manufacturing the magnetic tape cassette 31 according to the fourth embodiment. Incidentally, it is to be understood that the magnetic tape cassette 31 might be manufactured in various ways without being limited to the following process.

### Step S1

The upper shell 33 is molded. Molding of the upper shell 33 is carried out using the above insulating material such as polyester and plastic by means of well-known injection molding or the like, for instance.

### Step S2

The upper shell 33 molded in Step S1 is coated with the anti-static film by conductive coating using the above material according to the above method.

### Step S3

The lower shell 37 is molded. Molding of the lower shell is carried out using the above insulating material such as polyester and plastic by means of well-known injection molding or the like, for instance.

### Step S4

A surface of the lower shell 37 molded in Step S3 is coated with the anti-static film by conductive coating using the above material according to the above method.

### Step S5

The transparent window 34 is molded. Molding of the transparent window is carried out using the above transparent insulating material such as polyester and plastic by means of well-known injection molding or the like, for instance.

### Step S6

The transparent window 34 molded in Step S5 is coated with the transparent anti-static film by conductive coating using the above material according to the above method.

### Step S7

The lid 32 is molded. Molding of the lid is carried out using the above insulating material such as polyester and plastic by means of well-known injection molding or the like, for instance.

### Step S8

A surface of the lid 32 molded in Step S7 is coated with the anti-static film by conductive coating using the above material according to the above method.

### Step S9

The magnetic tape 35 is wound on the reels 36a, 36b. Step S10

A stopper and other parts are manufactured.

The upper shell 33 coated with the anti-static film in Step S2, the lower shell 37 coated with the anti-static film in Step S4, the transparent window 34 coated with the transparent anti-static film in Step S6, the lid 32 coated with the anti-static film in Step S8, the magnetic tape 35 wound on the reels 36a, 36b in Step S9 and the stopper or the like manufactured in Step S10 are assembled together.

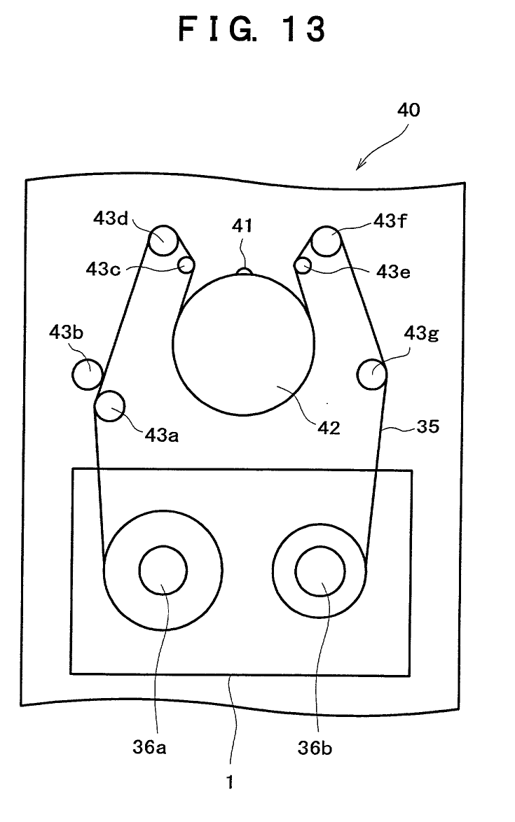

FIG. 13 is a perspective plan view showing the state of the magnetic tape cassette 31 thus manufactured when being mounted to a magnetic tape drive 40 serving as a magnetic recording/reproducing device.

As shown in FIG. 13, the magnetic tape cassette 31 mounted to the magnetic tape drive 40 is disposed close to a rotary drum 42 mounted with the magneto resistive head 41 and is further brought into contact with the rotary drum 42 through the magnetic tape 35. However, since at least either of the inside and the outside of the case inclusive of the lid 32, the upper shell 33, the transparent window 34 and the lower shell 37 of the magnetic tape cassette 31 is coated with the anti-static film to control electrostatic charging on the magnetic tape cassette 31 when being mounted to the magnetic tape drive 40 or being in operation and so on, the magneto resistive head 41 mounted to the rotary drum 42 may be prevented from electrostatic damages caused by static electricity generated on the magnetic tape cassette 31.

According to the fourth embodiment, since the anti-static measure is taken against the case inclusive of the lid 32, the upper shell 33, the transparent window 34 and the lower shell 37 of the magnetic tape cassette 31 as described the above to control electrostatic charging on the magnetic tape cassette 31 when being mounted or being in operation and so on, the magneto resistive head 41 may be prevented from electrostatic damages.

According to the fourth embodiment, since the anti-static measure is taken against the case inclusive of the lid 32, the upper shell 33, the transparent window 34 and the lower shell 37 by coating at least either of inside and outside of the case inclusive of the lid 32, the upper shell 33, the transparent window 34 and the lower shell 37 with the anti-static film to control electrostatic charging on the magnetic tape cassette 31, the magneto resistive head 41 may be also prevented from electrostatic damages.

Since the surface resistance of the anti-static film coated on at least either of the inside and the outside of the case inclusive of the lid 32, the upper shell 33, the transparent window 34 and the lower shell 37 is limited to the range of 0Ω/inch² or more to 1×10¹²Ω/inch² or less to control electrostatic charging on the magnetic tape cassette 31, the magneto resistive head 41 may be also prevented from electrostatic damages.

The anti-static film coated on at least either of the inside and the outside of the transparent window 34 is made transparent to permit the operation of ensuring the residual quantity or the like of the magnetic tape 35 through the transparent window 34.

Incidentally, it is to be understood that the present invention is not limited to the above embodiments. Although the magnetic tape cassette 31 having the case composed of the lid 32, the upper shell 33, the transparent window 34 and the lower shell 37 to coat at least either of the inside and the outside of each of the lid 32, the upper shell 33, the transparent window 34 and the lower shell 37 with the anti-static film is shown in the fourth embodiment, either of the inside and the outside of a case having other configuration may be also coated with the anti-static film.

Although at least either of the inside and the outside of the case of the magnetic tape cassette 31 is coated with the anti-static film to take the anti-static measure against the magnetic tape cassette 31 in the fourth embodiment, the anti-static measure taken by coating at least either of the inside and the outside of the case of the magnetic recording medium according to the present invention may be also applied to other magnetic recording mediums.

A description will now be given of a fifth embodiment according to the present invention. The fifth embodiment is referred to a modification of the fourth embodiment and is different from the fourth embodiment only in a way of the anti-static measure against the case. A difference between the fourth embodiment and the fifth embodiment will be described mainly in the following, while a description of portions common to the fourth and fifth embodiments will be omitted.

According to the fifth embodiment, with an anti-static measure by forming the case inclusive of the lid 32, the upper shell 33, the transparent window 34 and the lower shell 35 of a conductive material to control electrostatic charging on the magnetic tape cassette 31, the magneto resistive head 41 is prevented from electrostatic damages.

The conductive material for the lid 32 or the like according to the fifth embodiment preferably has a surface resistance of 1×10¹²Ω/inch² or less. This is because too high surface resistance of the conductive material for the information recording surface increases the possibility of causing electrostatic damages to the magneto resistive head with the increasing electrostatic charge on the case of the magnetic tape cassette 31 when being in operation.

A material used as the conductive material more preferably has a surface resistance of 0Ω/inch² or more, further more preferably 1×10⁶Ω/inch² or more, for instance. This is because too low surface resistance of the conductive material increases the possibility of causing electrostatic damages to the magneto resistive head 41 coming closer to the magnetic tape cassette 31 by abrupt transfer of charge accumulated on the magnetic tape cassette 31 toward the magneto resistive head 41 through the case as the magnetic tape cassette 31 is coming closer to the magneto resistive head 41.

Examples of the conductive material preferably include, for instance, a tin oxide material containing tin oxide doped with antimony, an indium oxide material containing indium oxide doped with tin and a zinc oxide material containing zinc oxide doped with aluminum or the like. Specifically, an anti-static agent-contained ABS resin “Toyolac Parrel-TP40”, which is commercially available from Toray Industries, Inc., Japan, or the like is desirable.

As the result of forming the surface of the case inclusive of the lid 32, the upper shell 33, the transparent window 34 and the lower shell 37 by using the anti-static agent-contained ABS resin “Toyolac Parrel-TP40” experimentally as one embodiment, it was proved that an absolute value of the electrostatic charge on the lid 32 or the like at a temperature of 27° C. with a humidity of 60% might be reduced to about 0 to 5V.

The conductive material for the portion of the transparent window 34 preferably includes a transparent material. With the use of the transparent material, transparency is provided securely for the transparent window 34 enough to permit the operation of ensuring the residual quantity or the like of the magnetic tape 35 through the transparent window 34. The conductive material for the transparent window 34 is not always completely colorless and transparent, but may include a somewhat colored transparent material or a semitransparent material having transparency of less than 100.

According to the fifth embodiment, since the case inclusive of the lid 32, the upper shell 33, the transparent window 34 and the lower shell 37 of the magnetic tape cassette 31 is formed of the conductive material to control electrostatic charging on the magnetic tape cassette 31 when being mounted or being in operation and so on, the magneto resistive head 41 may be prevented from electrostatic damages.

Since the surface resistance of the conductive material for the lid 32, the upper shell 33, the transparent window 34 and the lower shell 37 is limited to the range of 0Ω/inch² or more to 1×10¹²Ω/inch² or less to control electrostatic charging on the magnetic tape cassette 31, the magneto resistive head 41 may be also prevented from electrostatic damages.

The conductive material for the portion of the transparent window 34 is transparent enough to permit the operation of ensuring the residual quantity or the like of the magnetic tape 31 through the transparent window 34. Incidentally, it is to be understood that the present invention is not limited to the above embodiments. For instance, when the case inclusive of the lid 32, the upper shell 33 and the lower shell 37, other than the transparent window 34, may be formed of a metal such as stainless steel, the transparent window 34 may be formed of the above transparent conductive material.

Further, when the case inclusive of the lid 32, the upper shell 33 and the lower shell 37, other than the transparent window 34, is formed of a metal such as stainless steel, inside and outside of the transparent window 34 may be coated with the transparent anti-static film.

Although application of the present invention to the magnetic tape cassette 31 is shown in the fifth embodiment, the present invention is also applicable to the other magnetic recording mediums.

A description will now be given of a sixth embodiment according to the present invention.

The sixth embodiment is referred to a modification of the fourth embodiment and is different from the fourth embodiment only in a way of the anti-static measure taken against the case. A difference between the fourth embodiment and the sixth embodiment will be mainly described in the following, while a description of portions common to the fourth and sixth embodiments will be omitted.

According to the sixth embodiment, with an anti-static measure taken by providing a conductor part at least on a part of the surface of the case inclusive of a lid 52 and an upper shell 53 or the like to control electrostatic charging on the magnetic tape cassette 31, the magneto resistive head 41 is prevented from electrostatic damages.

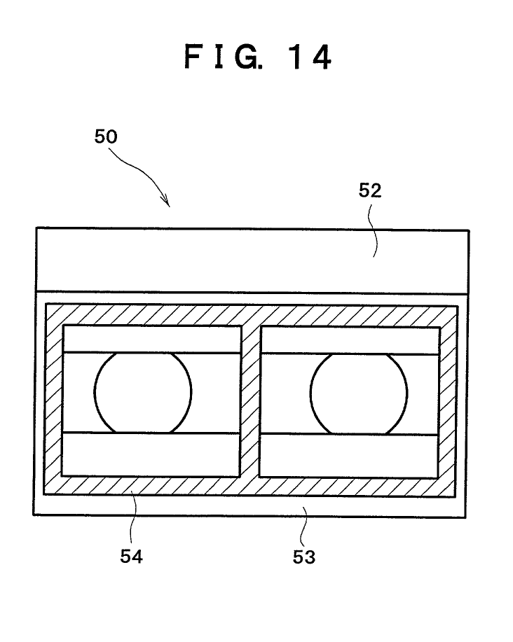

FIG. 14 is a plan view illustrating the configuration of a magnetic tape cassette 50 according to the sixth embodiment. The magnetic tape cassette 50 comprises the lid 52, the upper shell 53 and a conductor part 54 or the like. According to the sixth embodiment shown in FIG. 14, the conductor part 54 is formed on the upper surface of the upper shell 53 providing the upper surface of the case.

The case inclusive of the lid 52 and the upper shell 53 or the like may be formed of an insulating material such as plastic or may be coated with the anti-static film like the fourth embodiment or may be formed of the conductive material like the fifth embodiment.

A high conductive material inclusive of a metal such as stainless steel, for instance, will be available for the conductor part 54 without being limited in particular. The shape, layout and size of the conductor part 54 are freely determined without being limited to those shown in FIG. 14.

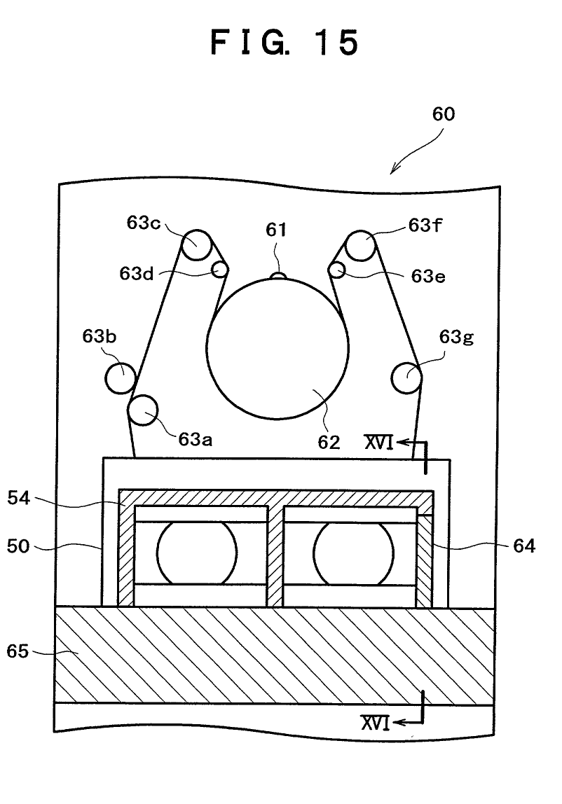

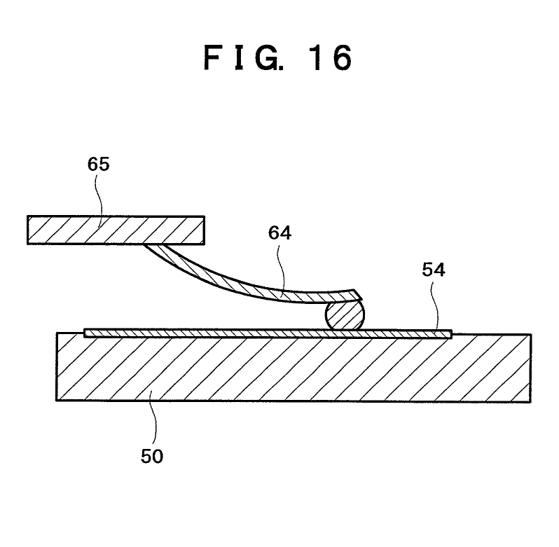

FIG. 15 is a perspective plan view illustrating a configuration of a magnetic tape drive 60 according to the sixth embodiment. FIG. 16 is a sectional view taken along line XVI-XVI in FIG. 15 showing the magnetic tape drive 60. As shown in FIG. 15, the magnetic tape drive 60 comprises, for instance, a magneto resistive head 61 for recording and/or reproducing information on a magnetic tape 55 incorporated in the magnetic tape cassette 50, a rotary drum 62 mounted with the magneto resistive head 61 and rotated in recording and/or reproducing information on the magnetic tape 55 with the magneto resistive head 61, tape guide rollers 63a to 63g for winding the magnetic tape 55 drawn from the magnetic tape cassette 50 on the rotary drum 62 while holding the magnetic tape 55, an earth arm 64 for connecting electrically the conductor part 54 provided on the surface of the case of the magnetic tape cassette 50 to the ground and an earth plate 65 connected electrically to the earth arm 64 and further connected electrically to the ground.

As shown in FIG. 16, the earth arm 64 is, for instance, in the shape of a leaf spring having one end connected electrically to the earth plate 65. When the magnetic tape cassette 50 mounted to the magnetic tape drive 60 is placed beneath the earth arm 64, one end of the earth arm 64, that is, the end free from connection to the earth plate 65, is allowed to press against the conductor part 54 provided on the surface of the mounted magnetic tape cassette 50. Thus, the conductor part 54 is allowed to connect electrically to the ground through the earth arm 64 and the earth plate 65. Accordingly, electrostatic charge accumulated on the magnetic tape cassette 50 may be emitted from the conductor part 54 to the ground through the earth arm 64 and the earth plate 65.

As shown in FIG. 15, the magnetic tape cassette 50 mounted to the magnetic tape drive 60 is placed close to the rotary drum 32 mounted with the magneto resistive head 61, for instance, and is further brought into contact with the rotary drum 62 through the magnetic tape 55. However, since the conductor part 54 is allowed to connect electrically to the ground through the earth arm 64 and the earth plate 65, the magnetic tape cassette 50 mounted to the magnetic tape drive 60 makes it possible to emit static electricity generated on the magnetic tape cassette 50 to the ground through the earth arm 64 or the like, and as a result, the magneto resistive head 61 mounted on the rotary drum 62 may be prevented from electrostatic damages caused by static electricity generated on the magnetic tape cassette 50.

According to the sixth embodiment, since the conductor part 54 is provided at least on a part of the surface of the case of the magnetic tape cassette 50, electrostatic charge accumulated on the magnetic tape cassette 50 may be emitted to the ground through the conductor part 54 to control electrostatic charging on the magnetic tape cassette 50 when being mounted or being in operation and so on, and as a result, the magneto resistive head 61 may be prevented from electrostatic damages.

Since the earth arm 64 is provided for the magnetic tape drive 60, static electricity generated on the magnetic tape cassette 50 mounted to the magnetic tape drive 60 may be emitted to the ground through the earth arm 64 or the like to control electrostatic charging on the magnetic tape cassette 50, and as a result, the magneto resistive head 61 may be prevented from electrostatic damages.

Incidentally, it is to be understood that the present invention is not limited to the above embodiments. Although application of the present invention to the magnetic tape cassette 50 is shown in the sixth embodiment, the present invention is also applicable to other magnetic recording mediums.

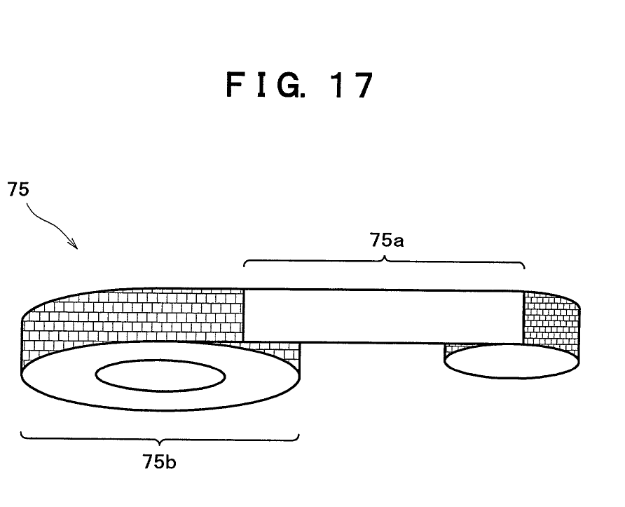

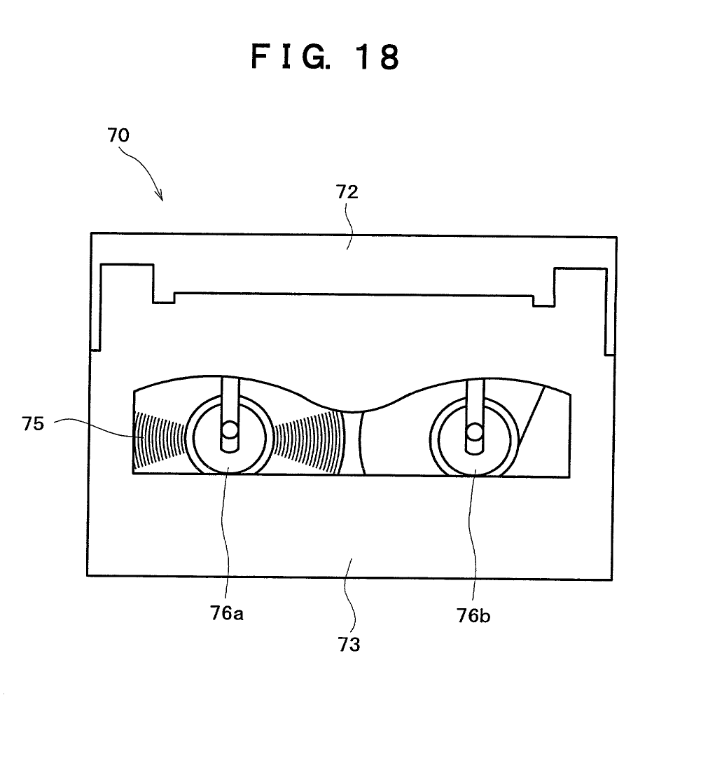

A description will now be given of a seventh embodiment according to the present invention. FIG. 17 is a perspective view showing a configuration of a magnetic tape 75 incorporated in a magnetic tape cassette serving as a magnetic recording medium according to the seventh embodiment. FIG. 18 is a plan view illustrating the external configuration of a magnetic tape cassette 70 according to the seventh embodiment.

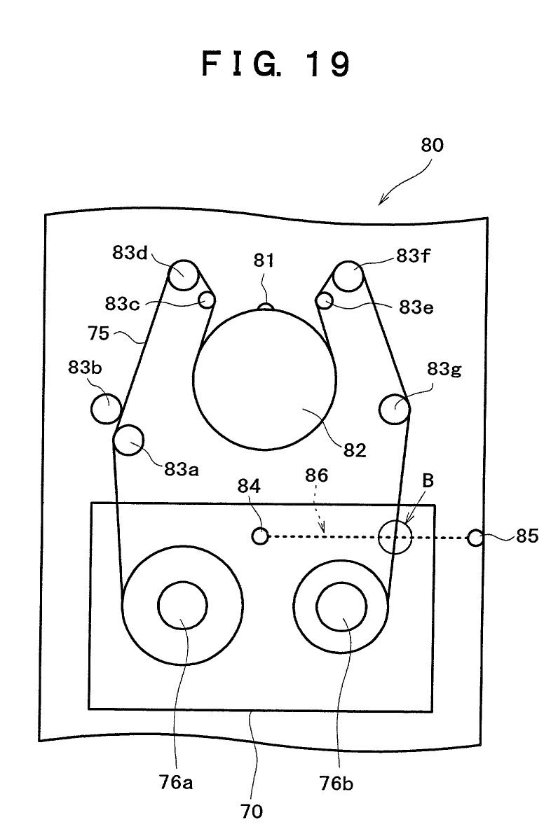

As shown in FIG. 17, the magnetic tape 75 has a leader tape part 75a provided at the tape end of the magnetic tape 75 and a magnetic recording tape part 75b allowed to record various kinds of information with a magneto resistive head 81 shown in FIG. 19.

A predetermined anti-static measure is taken against the leader tape part 75a to control electrostatic charging on the leader tape part 75a. According to the seventh embodiment, the anti-static measure may taken be by forming the leader tape part 75a of a conductive material.

The conductive material for the leader tape part 75a according to the seventh embodiment preferably has a surface resistance of from 1×10²Ω/inch² or more to 1×10¹²Ω/inch² or less, for instance. When the surface resistance of the conductive material becomes lower than 1×10²Ω/inch², current flowing through the magneto resistive head 81 causes short-circuiting to the magnetic tape 75, resulting in origination of noise. On the other hand, too high surface resistance of the information recording surface of the leader tape part 75a increases the possibility of causing electrostatic damages to the magneto resistive head 81 with the increasing electrostatic charge on the case of the magnetic tape cassette 70 when being in operation.

The conductive material for the leader tape part 75a more preferably has a surface resistance of from 1×10³Ω/inch² or more to 1×10¹²Ω/inch² or less, further more preferably, 1×10⁴Ω/inch² or more to 1×10¹²Ω/inch² or less, and still further more preferably, 1×10⁶Ω/inch² or more to 1×10¹²Ω/inch² or less. This is because too low surface resistance of the conductive material increases the possibility of causing electrostatic damages to the magneto resistive head 81 by abrupt transfer of charge accumulated on the magnetic tape cassette 70 toward the magneto resistive head 81 through the leader tape part 75a as the magnetic tape cassette 70 is coming closer to the magneto resistive head 81.

The conductive material for the leader tape part 75a preferably is a transparent material. This is because a photo sensor for detecting light transmitted through the leader tape part 75a is required for the magnetic tape drive 80 to detect the tape end of the mounted magnetic tape cassette 70. Its detailed description will be given later. Incidentally, the anti-static film is not always made completely colorless and transparent, but may be formed of a somewhat colored transparent material or a semi-transparent material having transparency of less than 100.

The leader tape part 75a may be also formed of an opaque conductive material. In this case, the leader tape part 75a may have a tape end detection hole allowing the passage of light for detecting the tape end.

The conductive materials having been described in the second embodiment are also available for the leader tape part 75a, for instance. The magnetic recording tape part 75b is composed of, for instance, a polymeric film such as polyethylene-naphthalate, polyetheretherketone, polyphenylene-sulfide, polyamide and polyimide and a ferromagnetic metal thin film such as Co, Co—Ni, Co—Fe, Co—Cr, Co—Ti, Co—Mo, Co—Ni—O, Co—Ni—P and Co—Cr—Nb formed on the polymeric film, and various kinds of information may be recorded onto the magnetic recording tape part 75b by magnetizing the ferromagnetic metal thin film with the magneto resistive head.

The magnetic tape 75 formed as described above is accommodated in a case composed of the lid 72 and the upper shell 73 or the like in a state of being wound on the reels 76a, 76b as shown in FIG. 18, providing the magnetic tape cassette 70.

FIG. 19 is a perspective plan view illustrating the configuration of the magnetic tape drive 80 according to the seventh embodiment. As shown in FIG. 19, the magnetic tape drive 80 comprises, for instance, the magneto resistive head 81 for recording and/or reproducing information on the magnetic tape 75 incorporated in the magnetic tape cassette 70, a rotary drum 82 mounted with the magneto resistive head 81 and rotated in recording and/or reproducing information on the magnetic tape 75 with the magneto resistive head 81, tape guide rollers 83a to 83g for winding the magnetic tape 75 drawn from the magnetic tape cassette 70 on the rotary drum 82 while holding the magnetic tape 75, a tape end detecting light emitter 84 for emitting light for detecting the tape end and a tape end detecting light detector 85 provided as a photo sensor for detecting the light emitted from the tape end detecting light emitter 84.

The magnetic tape 75 is drawn from the magnetic tape cassette 70 mounted to the magnetic tape drive 80 with the tape guide rollers 83a and 83c to 83g. The magnetic tape 75 drawn with the tape guide rollers 83a and 83c to 83g is then wound on the rotary drum 82 with the tape guide rollers 83a and 83c to 83g transferred so as to enclose the rotary drum 82 mounted with the magneto resistive head 81, while being brought into contact with the rotary drum 82, as shown in FIG. 19. The operation of recording and/or reproducing information on the magnetic tape 75 is carried out by rotating the rotary drum 82 with the magnetic tape 75 brought into contact with the rotary drum 82 as described the above, while allowing the magnetic tape 75 to travel by rotating the reels 76a, 76b.

In this case, light 86 for detecting the tape end is being emitted from the tape end detecting light emitter 84. The direction of emission of the tape end detecting light 86 is orthogonal to the magnetic tape 75 in a portion B shown in FIG. 19, and the tape end detecting light detector 85 is provided at a position enough to detect the tape end detection light 86 emitted from the tape end detecting light emitter 84 through the magnetic tape 75. Since the magnetic recording tape part 75b in the magnetic tape 75 is made opaque, the tape end detecting light 86 emitted from the tape end detecting light emitter 84 is shielded with the magnetic recording tape part 75b in the portion B if the magnetic tape 75 has not yet reached the tape end. In this case, the tape end detecting light 86 is not detected with the tape end detecting light detector 85, and as a result, it is decided that the magnetic tape has not reached yet the tape end. On the other hand, when the magnetic tape 75 reached the tape end, the leader tape part 75a provided at the tape end is considered to be located at the portion B. When the leader tape part 75a is formed of the transparent material or has the tape end detecting hole as described above, the tape end detecting light 86 is allowed to pass through the leader tape part 75a in the portion B. Thus, the tape end detecting light 86 having passed through the leader tape part is detected with the tape end detecting light detector 85, and as a result, it is decided that the magnetic tape 75 reached the tape end.

As shown in FIG. 19, the magnetic tape cassette 70 mounted to the magnetic tape drive 80 is placed close to the rotary drum 82 mounted with the magneto resistive head 81, for instance, and is further brought into contact with the rotary drum 82 through the magnetic tape 75. However, since the leader tape part 75a is formed of the conductive material as described the above to control electrostatic charging on the leader tape part 75a, the magneto resistive head 81 mounted to the rotary drum 82 may be prevented from electrostatic damages.

According to the seventh embodiment, since the anti-static measure is taken against the leader tape part 75a of the magnetic tape 75 to control electrostatic charging on the leader tape part 75a of the magnetic tape cassette 70 when being in operation and so on, the magneto resistive head 81 may be prevented from electrostatic damages.

According to the seventh embodiment, since the anti-static measure is taken against the leader tape part 75a by forming the leader tape part 75a of the conductive material to control electrostatic charging on the leader tape part 75a, the magneto resistive head 81 may be also prevented from electrostatic damages.

Since a surface resistance of the conductive material for the leader tape part 75a is limited preferably to the range of 1×10²Ω/inch² or more to 1×10¹²Ω/inch² or less, more preferably, 1×10³Ω/inch² or more to 1×10¹²Ω/inch² or less, further more preferably, 1×10⁴Ω/inch² or more to 1×10¹²Ω/inch² or less, and still further more preferably, 1×10⁶Ω/inch² or more to 1×10¹²Ω/inch² or less to control electrostatic charging on the leader tape part 75a, the magneto resistive head 81 may be also prevented from electrostatic damages.

Further, the tape end may be detected with the tape end detecting light detector 85 by forming the leader tape part 75a of the conductive material including the transparent material.

Incidentally, it is to be understood that the present invention is not limited to the above embodiments.

A description will now be given of an eighth embodiment according to the present invention. The eighth embodiment is referred to a modification of the seventh embodiment and is different from the seventh embodiment only in a way of the anti-static measure against the leader tape part 75a. A difference between the seventh embodiment and the eighth embodiment will be mainly described in the following, while a description of portions common to the seventh and eighth embodiments will be omitted.

According to the eighth embodiment, with an anti-static measure taken by coating the leader tape part 75a with an anti-static film to control electrostatic charging on the leader tape part 75a, the magneto resistive head 81 is prevented from electrostatic damages. To coat the leader tape part 75a with the anti-static film in the eighth embodiment means to coat at least either of front and rear surfaces of the leader tape part 75a with the anti-static film.

The anti-static film coated on the leader tape part 75a according to the eighth embodiment preferably has a surface resistance of from 1×10²Ω/inch² or more to 1×10¹²Ω/inch² or less, for instance. When the surface resistance of the anti-static film becomes lower than 1×10²Ω/inch², current flowing through the magneto resistive head 81 causes short-circuiting to the magnetic tape 75, resulting in origination of noise. On the other hand, too high surface resistance of the anti-static film increases the possibility of causing electrostatic damages to the magneto resistive head 81 with the increasing electrostatic charge on the case of the magnetic tape cassette 70 when being in operation.

The anti-static film coated on the leader tape part 75a more preferably has surface resistance of from 1×10³Ω/inch² or more to 1×10¹²Ω/inch² or less, further more preferably, 1×10⁴Ω/inch² or more to 1×10¹²Ω/inch² or less, and still further more preferably, 1×10⁶Ω/inch² or more to 1×10¹²Ω/inch² or less. This is because too low surface resistance of the anti-static film increases the possibility of causing electrostatic damages to the magneto resistive head 81 by abrupt transfer of charge accumulated on the magnetic tape cassette 70 toward the magneto resistive head 81 through the leader tape part 75a as the magnetic tape cassette 70 is coming closer to the magneto resistive head 81.

The anti-static film coated on the leader tape part 75a is preferably made transparent by a similar reason to the seventh embodiment. The leader tape part 75a may be also coated with an opaque anti-static film. In this case, the leader tape part 75a may have the tape end detecting hole allowing the passage of light for detecting the tape end.

The anti-static films having been described in the fourth embodiment are also available for the anti-static film coated on the leader tape part 75a, for instance. According to the eighth embodiment, since the anti-static measure is taken against the leader tape part 75a by coating the leader tape part 75a with the anti-static film to control electrostatic charging on the leader tape part 75a, the magneto resistive head 81 may be prevented from electrostatic damages.

Since a surface resistance of the anti-static film coated on the leader tape part 75a is preferably limited to the range of 1×10²Ω/inch² or more to 1×10¹²Ω/inch² or less, more preferably, 1×10Ω³/inch² or more to 1×10¹²Ω/inch² or less, further more preferably, 1×10⁴Ω/inch² or more to 1×10¹²Ω/inch² or less, and still further more preferably, 1×10⁶Ω/inch² or more to 1×10¹²Ω/inch² or less to control electrostatic charging on the leader tape part 75a, the magneto resistive head 81 may be also prevented from electrostatic damages.

Further, the tape end may be detected with the tape end detecting light detector 85 by coating the leader tape part 75a with the anti-static film formed of the transparent material.

Incidentally, it is to be understood that the present invention is not limited to the above embodiments.

A description will now be given of a ninth embodiment according to the present invention. The ninth embodiment is also referred to a modification of the seventh embodiment and is different from the seventh embodiment only in a way of the anti-static measure against the leader tape part. A difference between the seventh embodiment and the ninth embodiment will be mainly described in the following, while a description of portions common to the seventh and ninth embodiments will be omitted.

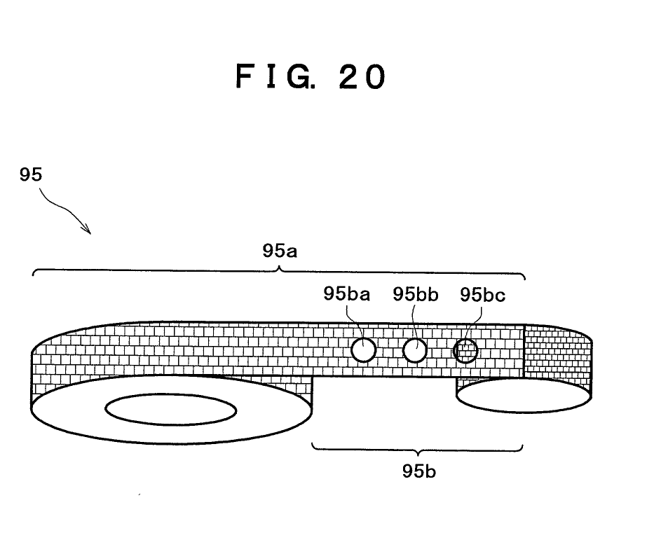

FIG. 20 is a perspective view illustrating the configuration of a magnetic tape 95 incorporated in the magnetic tape cassette 70 according to the ninth embodiment. According to the ninth embodiment, with an anti-static measure by providing no leader tape part for the magnetic tape 95 as shown in FIG. 20 to eliminate electrostatic charging on the leader tape part, the magneto resistive head 81 is prevented from electrostatic damages.

Provided that a tape end 95b of a magnetic recording tape part 95a allowed to record various kinds of information needs to have tape end detecting holes 95ba to 96bc allowing the passage of light for detecting the tape end, thus enabling detection of the tape end 95b.

According to the ninth embodiment, since the anti-static measure is by providing no leader tape part for the tape end 95b to eliminate electrostatic charging on the leader tape part, the magneto resistive head 81 may be prevented from electrostatic damages.

Also, since the tape end detecting holes 95ba to 95bc allowing the passage of light for detecting the tape end are provided in the tape end 95b, the tape end may be detected with the tape end detecting light detector 85.

Incidentally, it is to be understood that the present invention is not limited to the above embodiments.

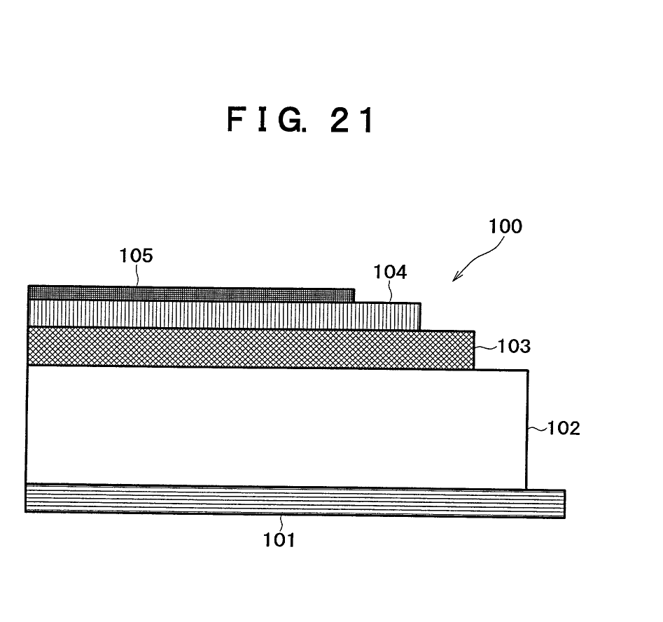

A description will now be given of a tenth embodiment according to the present invention with reference to FIG. 21.

FIG. 21 is an enlarged sectional view illustrating the detailed configuration of a magnetic tape 100. As shown in FIG. 21, the magnetic tape 100 comprises, for instance, a base 102 formed on the upper surface of a back layer 101, a magnetic layer 103 formed on the upper surface of the base 102, a carbon protective layer 104 formed on the upper surface of the magnetic layer 103 to protect the magnetic layer 103 and a lubricant layer 105 formed on the upper surface of the carbon protective layer 104.

The back layer 101 includes, for instance, particle coat formed by fixing fine particles such as carbon powder and calcium carbide powder with a resin such as polyurethane, polyester and polyimide and is for providing higher traveling performance of the magnetic tape 100.

The base 102 includes, for instance, a polymeric film such as polyethylene-naphthalate, polyether-etherkenone, polyphenylene-sulfide, polyamide and polyimide, and a water soluble polymeric undercoat or a particle coat will be also available at need.

The magnetic layer 103 includes, for instance, a ferromagnetic metal thin film such as Co, Co—Ni, Co—Fe, Co—Cr, Co—Ti, Co—Mo, Co—Ni—O, Co—Ni—P and Co—Cr—Nb and is referred to a layer magnetized with the magneto resistive head for recording various kinds of information.

The magnetic layer 103 is preferably formed such that the information recording surface on the side of the lubricant layer 105 has a surface resistance of from 10³Ω/inch² or more to 10¹²Ω/inch² or less, for instance. This is because too low surface resistance of the information recording surface of the magnetic tape 100 increases the possibility of causing electrostatic damages to a magneto resistive head (not shown) by abrupt transfer of charge accumulated on the magnetic tape 100 toward the magneto resistive head (not shown) coming closer to the magnetic tape 100 while keeping in contact therewith through the magnetic tape 100 in recording and/or reproducing information on the magnetic tape 100. On the other hand, too high surface resistance of the information recording surface of the magnetic tape 100 increases also the possibility of causing electrostatic damages to the magneto resistive head (not shown) with the increasing electrostatic charge on the magnetic tape 100 when being in operation.

In the magnetic tape 100 having the information recording surface having the surface resistance of from 10³Ω/inch² or more to 10¹²Ω/inch² or less as described the above, it is desirable that the magnetic layer 103 has thickness of from 10 nm or more to 100 nm or less and also contains oxygen in an amount of from 20 atm % or more to 30 atm % or less in the whole magnetic layer 103.

The carbon protective layer 104 is formed on the surface of the magnetic layer by means of a thin filming technique such as sputtering and CVD and is mainly for providing higher traveling performance and durability of the magnetic tape.

The lubricant layer 105 is formed of, for instance, perfluorostearic acid or the like and is referred to a layer having the effect of reducing the friction between the magnetic tape 100 and the magneto resistive head (not shown) when the magnetic tape 100 is in traveling operation.

According to the tenth embodiment, since the surface resistance of the information recording surface of the magnetic tape 100 is limited to 10³Ω/inch² or more as described the above to control abrupt transfer of charge accumulated on the magnetic tape 100 toward the magneto resistive head (not shown) coming closer to the magnetic tape 100 while keeping in contact therewith through the magnetic tape 100 in recording and/or reproducing information on the magnetic tape 100, the magneto resistive head (not shown) may be prevented from electrostatic damages.

According to the tenth embodiment, since the surface resistance of the information recording surface in the magnetic tape 100 is also limited to 10¹²Ω/inch² or less to control electrostatic charging on the magnetic tape 100 when being in operation, the magneto resistive head 121 may be also prevented from electrostatic damages.

Incidentally, it is to be understood than the present invention is not limited to the above embodiments.

What is claimed is:

1. A magnetic recording medium for recording and/or reproducing information with a magneto resistive head, wherein an anti-static measure is taken against tape guide parts for holding a magnetic tape at a leader tape part of said magnetic tape.

2. A magnetic recording medium according to claim 1, wherein said anti-static measure is taken by forming said tape guide parts of a conductive material.

3. A magnetic recording medium according to claim 2, wherein said conductive material has a surface resistance of from 0Ω/inch² or more to 1×10¹²Ω/inch² or less.

4. A magnetic recording medium according to claim 2, wherein said conductive material is a metal.

5. A magnetic recording medium according to claim 2, wherein said tape guide parts have respectively roller rotary mechanisms formed of said conductive material, and said magnetic tape is held with said roller rotary mechanisms.

6. A magnetic recording medium according to claim 1, wherein said anti-static measure is taken by coating said tape guide parts with an anti-static film.

7. A magnetic recording medium according to claim 6, wherein said anti-static film has a surface resistance of from 0Ω/inch² or more to 1×10¹²Ω/inch² or less.

8. A magnetic recording medium according to claim 6, wherein said anti-static film is a metal coat.

9. A magnetic recording medium according to claim 6, wherein said tape guide parts have respectively roller rotary mechanisms coated with said anti-static film, and said magnetic tape is held with said roller rotary mechanisms.

10. A magnetic recording medium according to claim 1, further comprising conductive machine screws on a bottom thereof, said conductive machine screws being connected electrically to the ground when said magnetic recording medium is mounted to a magnetic recording/reproducing device.

11. A magnetic recording medium for recording and/or reproducing information with a magneto resistive head, wherein an anti-static measure is taken against a case.

12. A magnetic recording medium according to claim 11, wherein said anti-static measure is taken by coating at least either of the inside and the outside of said case with an anti-static film.

13. A magnetic recording medium according to claim 12, wherein said anti-static film has a surface resistance of from 0Ω/inch² or more to 1×10¹²Ω/inch² or less.

14. A magnetic recording medium according to claim 12, wherein said anti-static film coated on at least either of inside and outside of a transparent window of said case is made transparent.

15. A magnetic recording medium according to claim 11, wherein said anti-static measure is taken by forming said case of a conductive material.

16. A magnetic recording medium according to claim 15, wherein said conductive material has a surface resistance of from 0Ω/inch² or more to 1×10¹²Ω/inch² or less.

17. A magnetic recording medium according to claim 15, wherein said conductive material for a transparent window portion of said case is a transparent material.

18. A magnetic recording medium according to claim 15, wherein said conductive material for portions of said case other than a transparent window is a metal, and said conductive material for said transparent window portion is a transparent material.

19. A magnetic recording medium according to claim 11, wherein said anti-static measure is taken by forming portions of said case, other than a transparent window, of a metal, while coating at least either of inside and outside of said transparent window with a transparent anti-static film.

20. A magnetic recording medium according to claim 11, wherein said anti-static measure is taken by providing a conductor part at least on a part of a surface of said case.

21. A magnetic recording medium according to claim 20, wherein said conductor part is formed on an upper surface of said case.

22. A magnetic recording medium according to claim 20, wherein said conductor part is connected electrically to the ground when said magnetic recording medium is mounted to a magnetic recording/reproducing device.

23. A magnetic recording medium for recording and/or reproducing information with a magneto resistive head, wherein an anti-static measure is taken against a leader tape part of a magnetic tape.

24. A magnetic recording medium according to claim 23, wherein said anti-static measure is taken by forming said leader tape part of a conductive material.

25. A magnetic recording medium according to claim 24, wherein said conductive material has a surface resistance of from 1×10²Ω/inch² or more to 1×10¹²Ω/inch² or less.

26. A magnetic recording medium according to claim 24, wherein said conductive material has a surface resistance of from 1×10³Ω/inch² or more to 1×10¹²Ω/inch² or less.

27. A magnetic recording medium according to claim 24, wherein said conductive material has a surface resistance of from 1×10⁴Ω/inch² or more to 1×10¹²Ω/inch² or less.

28. A magnetic recording medium according to claim 24, wherein said conductive material has a surface resistance of from 1×10⁶Ω/inch² or more to 1×10¹²Ω/inch² or less.

29. A magnetic recording medium according to claim 24, wherein said conductive material is a transparent material.

30. A magnetic recording medium according to claim 24, wherein said leader tape part has a tape end detecting hole allowing a light to pass therethrough for detecting a tape end.

31. A magnetic recording medium according to claim 23, wherein said anti-static measure is taken by coating said leader tape part with an anti-static film.

32. A magnetic recording medium according to claim 31, wherein said anti-static film has a surface resistance of from 1×10²Ω/inch² or more to 1×10¹²Ω/inch² or less.

33. A magnetic recording medium according to claim 31, wherein said anti-static film has surface resistance of from 1×10³Ω/inch² or more to 1×10¹²Ω/inch² or less.

34. A magnetic recording medium according to claim 31, wherein said anti-static film has surface resistance of from 1×10⁴Ω/inch² or more to 1×10¹²Ω/inch² or less.

35. A magnetic recording medium according to claim 31, wherein said anti-static film has surface resistance of from 1×10⁶Ω/inch² or more to 1×10¹²Ω/inch² or less.

36. A magnetic recording medium according to claim 31, wherein said anti-static film is formed of a transparent material.

37. A magnetic recording medium according to claim 31, wherein said leader tape part has a tape end detecting hole allowing a light to pass therethrough for detecting a tape end.

38. A magnetic recording medium for recording and/or reproducing information with a magneto resistive head, wherein a tape end of a magnetic tape has no leader tape part but has a tape end detecting hole allowing a light to pass therethrough for detecting the tape end.

39. A magnetic recording/reproducing device having a magneto resistive head, comprising:
an earth arm for connecting electrically a conductor part provided on a surface of a case of a mounted magnetic recording medium to the ground.

40. A magnetic recording/reproducing device for recording and/or reproducing information with a magneto resistive head, wherein an information recording surface for recording said information has a surface resistance of from 10³Ω/inch² ² or more to 10¹²Ω/inch² or less.

41. A magnetic recording/reproducing device according to claim 40, wherein a magnetic layer has a thickness of from 10 nm or more to 100 nm or less.

42. A magnetic recording/reproducing device according to claim 40, wherein a magnetic layer contains oxygen in an amount of from 20 atm % or more to 30 atm % or less in a whole magnetic layer.

43. A magnetic recording/reproducing device according to claim 40, wherein operation of recording and/or reproducing said information is carried out with said magneto resistive head keeping in contact with said information recording surface.
